(19) United States
(12) Patent Application Publication
(10) Pub. No.: US 2016/0320862 A1
(43) Pub. Date: Nov. 3, 2016

(54) MOTION CONTROL SEAT INPUT DEVICE

(71) Applicants: Aaron Schradin, West Olive, MI (US); Simon Solotko, Austin, TX (US)

(72) Inventors: Aaron Schradin, West Olive, MI (US); Simon Solotko, Austin, TX (US)

(21) Appl. No.: 14/789,984

(22) Filed: Jul. 1, 2015

Related U.S. Application Data
(60) Provisional application No. 61/986,881, filed on May 1, 2014.

(51) Int. Cl. G06F 3/0338; G06F 3/01; A47C 3/18; A47C 1/00; A47C 7/56

(52) U.S. Cl. CPC G06F 3/0338; A47C 1/00; A47C 7/56; A47C 3/18; G06F 3/012; G06F 3/015

(57) ABSTRACT

An input device for providing user input to a computing device includes a seat portion allowing a user to sit on the device. The input device further includes several positional sensors that detect changes in pitch, yaw and roll and convert those detected changes to a control signal for operating functions on a computing device and/or providing input to applications running on the computing device.

### STATEMENT REGARDING FEDERALLY SPONSORED RESEARCH

NA

### CROSS REFERENCE TO RELATED APPLICATIONS

This application claims priority to provisional application No. 61/986,881 filed on May 1, 2014.

### FIELD OF THE INVENTION

The present invention relates to seating devices and methods for providing interactive control of a computing device. More particularly a modular ergonomic seating device for providing input for a computing device.

### BACKGROUND OF THE INVENTION

In order for humans to interact and operate computers, external input devices are generally required. Signals from these external input devices are received by the computer and processed to act as a control signal for controlling an aspect of the computer's function and/or applications (programs) running on the computer.

Traditionally, input devices such as keyboards, mice, game controllers and the like have focused on receiving input movements from the hands and particularly the fingers of users. While these have proven effective, they are poorly suited for more immersive, intuitive control schemes. The development of immersive computer generated environments such as those used for gaming, social interaction, computer aided design and other similar functions have highlighted the need for new input devices. Of particular note is the rise of augmented reality (“AR”) and virtual reality (“VR”) technology that enables users to be fully immersed in computer generated environments. AR and VR technology platforms are poorly suited for traditional input methods as they can break immersion and detract from the user's experience.

### SUMMARY OF THE INVENTION

As specified in the Background Section above, there is a need for improved devices and methods for providing user input for controlling and or interacting with a computing device.

Therefore an embodiment of the present invention is an input device comprising a user engaging portion; a plurality of positional sensors, the plurality of positional sensors further comprising; at least one pitch sensor; at least one yaw sensor; at least one roll sensor; and a coupling mechanism capable of coupling the input device to a computing device such that the sensing mechanisms can send data to the computing device. In use, a user will sit on, or straddle the user engaging portion of the device and lean forwards/backwards, lean side/side, and/or rotate the device. These motions by the user will be detected by the sensors and converted to control signal(s) which are transmitted to a computing device and used to interact with the computing device and/or an application (program) running on the computing device.

An embodiment is a rotating sensor seat for providing freedom of movement useful for users employing motion based input or head mounted displays. The seat has a base, a rotating platform, cushions, adjustment controls and accessory attachment points. The seat has the advantage that the user is able to place their legs in a straddle position about the seat for rotational control, tilt control and balance. In some embodiments of the seat, integrated sensors detect movement, position, and provide interactive feedback. In some embodiments, attachments and accommodations for external motion trackers and tracking head mounted displays are incorporated to ensure an ergonomic interface between the interface device, the user and the seat. In some embodiments one or more components of the seat is a stackable module permitting user assembly and customization through the use of interchangeable components.

In at least one embodiment the invention includes electronic control interfaces and sensors to measure pressure, position, rotational measurement, and bio-input which enables the control of interactive software when connected by wire or wirelessly to a computing device including a smartphone, tablet, handheld gaming device, or interactive computing device. Interactive sensors measure user movement and position including: tilt for providing both directional and intensity input similar to data provided by a handheld joystick with real-time x and y coordinates; rotational position; user weight and change of pressure against the top of the seat on the vertical axis; user position measured and position changes on multiple axes. In at least one embodiment user weight is used to determine the identity of the user and employed for calibration of seat interactive sensor settings and made available via an application program interface to an interfaced computing device. Biofeedback through interactive sensors is provided through a software interface.

Much like riding a horse, forces of instability caused by gesture and motion interfaces and the instability inherent in wearing a head mounted display are counteracted as the user utilizes their lower body to straddle the seat and maintain balance. A further advantage is that the user is positioned to precisely rotate the seat with their legs in a straddle position, with small pushes of the feet providing rotational force orthogonal to the axis of rotation and closely aligned the rotational freedom of the invention and to adjust their position to control interactive software while maintaining balance. A further advantage is that users are able to control interactive software with fine precision which can be measured with an integrated sensor, with external motion controls and a tracking head mounted display.

In at least one embodiment the cushion in multiple sizes accommodates different user heights and body types.

In at least one embodiment the seat cushion is made from a flexible inflatable material which is filled with air and filler and ballast with the advantage of body contouring support for the lower body and legs of the user maintaining ergonomic body position. Another advantage of flexible inflatable material is deflation for shipment and easy user inflation for installation with the ability to customize air pressure, filler and ballast for user preferences and body types. An additional advantage is when deflated the flexible inflatable material reduces the total volume of the seat for shipment or user storage. In at least one embodiment the flexible inflatable materials is a modular component held in place by a retaining base with the advantage of increasing the stability of the cushion while retaining ergonomic, packaging, and additional advantages of the material.

The flexible inflatable cushion has the advantage of ergonomic seating position similar to an exercise ball with additional stability featuring a cylindrical or pod shape with increased range of user leg and feet motion.

In at least one embodiment the seat is composed of stacking modules with close, contoured interfaces with the advantage of reconfiguration by the end user and simple assembly for interactive control, user adjustment, or feature customization. A further advantage of the stacking modules with close contoured interfaces is few protruding points diminishing the chance of cord tangles from external controllers or head mounted displays. An additional advantage of stacking modules is easy manufacturing, packaging and user assembly of the finished seat.

In at least one embodiment the seat is constructed from interconnected modules with the advantage of ease of assembly and user configuration where modules can include: a base platform adjusting the height and weight of the seat; a rotational platform with variable stops for allowing the user to turn freely or prevent continuous turning; electronic interactive sensors; a retaining base; a cushion; a back support unit; an arm support unit; a cable management unit; a platform or compartment for storage.

In at least one embodiment the seat is constructed from interconnected modules with the advantage of ease of assembly and user configuration where modules can include: a base platform adjusting the height and weight of the seat; a rotational platform with variable stops for allowing the user to turn freely or prevent continuous turning; electronic interactive controls; a cushion interface; a cushion; a back support unit; an arm support unit; a cable management unit; a platform or compartment for storage.

### BRIEF DESCRIPTION OF THE DRAWINGS

FIG. 1 shows a perspective view and a side view in accordance with an embodiment of the disclosure;

FIG. 2 shows an exploded perspective view of seat modules in accordance with an embodiment of the disclosure;

FIG. 3 shows a top view of the rotational platform base and its top shown in accordance with an embodiment of the disclosure;

FIG. 4 shows a seat perspective view and side view in accordance with an embodiment of the disclosure;

FIG. 5 shows a perspective view with a seated user and illustrations of motion on multiple axes in accordance with an embodiment of the disclosure;

FIG. 6 shows a seat perspective view and a side view in accordance with an embodiment of the disclosure;

FIG. 7 shows a side view with a seated user and an illustration of motion on multiple axes in accordance with an embodiment of the disclosure;

FIG. 8 shows side cut away views and perspective detail views in accordance with an embodiment of the disclosure;

FIG. 9 shows side view and side cut away detail views in accordance with an embodiment of the disclosure;

FIG. 10 shows a seat side and perspective view in accordance with an embodiment of the disclosure;

FIG. 11 shows a flow chart of communication of the invention with interactive computing devices in accordance with an embodiment of the disclosure;

FIG. 12 shows a semi exploded view of an embodiment of an input device of the present disclosure.

FIG. 13 shows a semi exploded view of an embodiment of the rotation portion of the input device.

FIG. 14 shows a semi exploded view of aspects of the control switches for the input device on the seat portion.

FIG. 15 shows a close up look of the gimbal.

### DETAILED DESCRIPTION OF THE INVENTION

In the following, reference is made to embodiments of the disclosure. However, it should be understood that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

An embodiment is an input device comprising a user engaging portion; a plurality of positional sensors, the plurality of positional sensors further comprising; at least one pitch sensor; at least one yaw sensor; at least one roll sensor; and a coupling mechanism capable of coupling the input device to a computing device such that the sensing mechanisms can send data to the computing device.

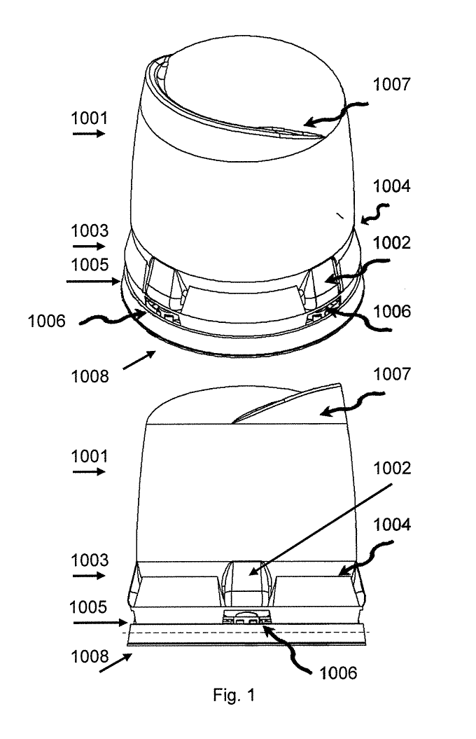

Turning now to the figures. FIG. 1 shows one embodiment of an input device of the present disclosure taking the form of a rotating sensor seat shown here in perspective and in profile. In this embodiment the seat is composed of stacking modules for reconfiguration by the end user and simple assembly for interactive control, user adjustment, and/or feature customization. A cushion 1001 features a lip 1007 with a taper that allows the legs to straddle the sides of the seat. In some embodiments the cushion is flexible and inflatable thermoplastic polymer further permitting conformity to the seated user as the seat conforms to the inner thighs. In some embodiments, the cushion includes shaped stabilizing feet 1002 that fit into the shaped intersection 1004 of the retaining base 1003 and the cushion 1001. The stabilizing feet have the advantage of providing a rigid joint for the intersection with the retaining base resistant to torsional or lateral forces thereby providing enhanced stability. The cushion can be partially filled with weighted filler material or ballast such as sand to ensure further stability within the retaining base.

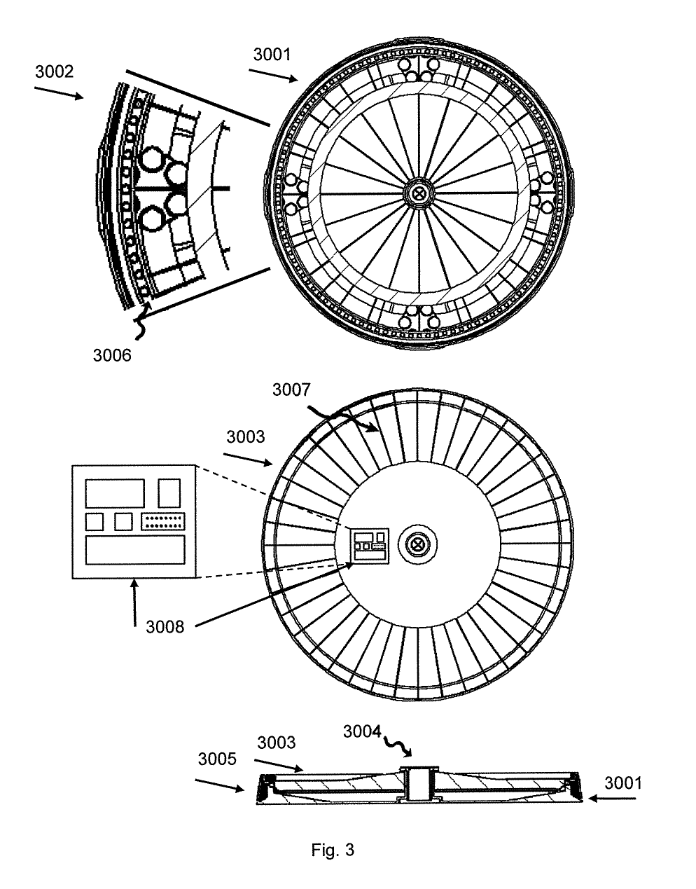

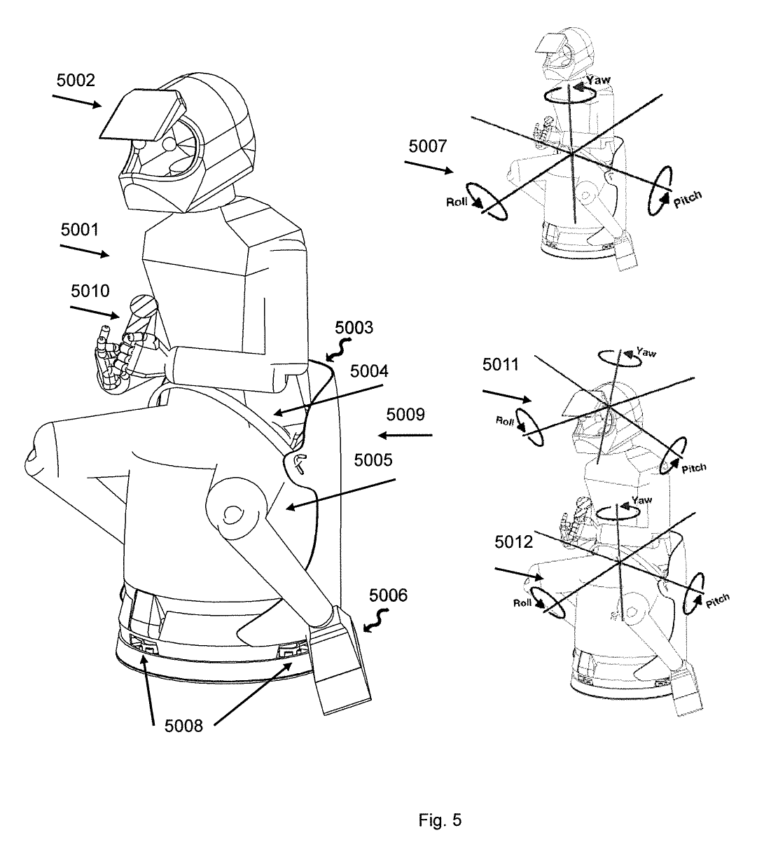

In further detail, still referring to the invention of FIG. 1, the series of close, contoured interfaces between modules provides a smooth surface for the entire profile of the seat with the advantage of minimizing interference with cables, clothing or user feet and legs. This smooth profile rotates at the interface to the rotating platform 1005 with the advantage that the user's leg is able to rest against the cushion 1001 down to the interface of the retaining base and rotating platform 1005 such that the seat rotates with, and in contact with the user's lower body in a straddle position. The combination of rotation of the seat with the user and the cushion is increased stability where the user's feet, legs, and torso partially embrace the rotating seat providing a leverage point for maintaining seating stability. A further advantage of this position is that the user is positioned to precisely rotate the seat with their legs straddling the side of the seat as in FIG. 5 5005, with small pushes of the feet FIG. 5 5006 providing rotational force orthogonal to the axis of rotation and closely aligned the rotational freedom of the rotating base 1008. The rotational base 1008 and cushion platform 1005 in smaller or larger heights or profiles and with a detachable riser platform have the advantage of providing customizable dimensions to different user heights, weights, preferences, and interactive control capabilities. Interactive base sensors 1006 provide sensor feedback to an electronic circuit board FIG. 3 3008 with the advantage of translating user motion into control signals for motion and functional control of software applications running on a computing device. In this embodiment multiple base sensors are arranged in a configuration that permits multiple points of acquiring input for detection of the direction a user is leaning or rotating.

In additional detail, still referring to FIG. 1, interactive sensors 1006 have the advantage of allowing subtle user movements to be translated into motion input, direction of movement, and/or function selection in an interactive software application when employed with a computing device. The interactive sensors 1006 have the advantage of pressure sensitivity such that direction is derived through comparison of all sensors with intensity measured and translated into primitive data and commands for control of a computing device. Pressure on evenly placed sensors has the advantage of interpretation as a desire to move in the direction of the interpreted region, either directly on a sensor on based on weighted average between multiple sensors. Calibration of sensors is accomplished by a user sitting in multiple positions and making core body movements, with measurement spanning all sensors and retained by software and employed for later comparison. Feedback and interaction may also be provided by software input from these devices to interactive sensors such as those in 1006 for feedback including but not limited to sound, vibration, light, light effects, steam or smoke, and other interactive effects.

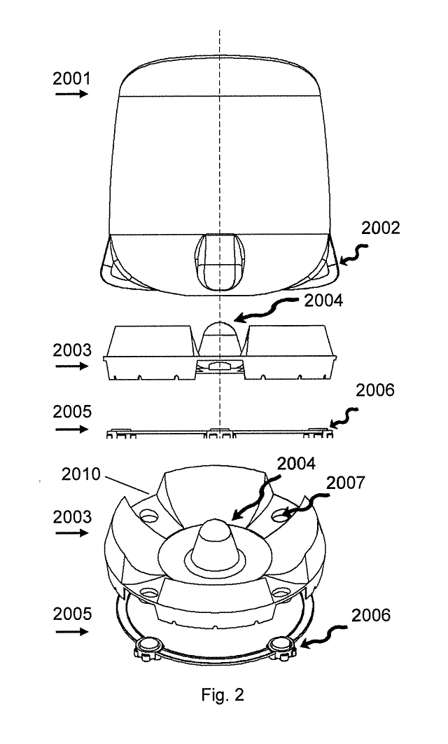

Referring now to FIG. 2, the construction details of the embodiments shown in FIG. 1 to FIG. 5, the cushion 2001 is detachable and usable as a seat in a stand-alone configuration by removal from the retaining base 2003 and placement on a floor or other surface. In some embodiments the retaining base further comprises a plurality of grooves 2010 adapted to engage the stabilizing feet on the cushion. In this use the stabilizing feet 2002 have the advantage of providing additional stability against forces on multiple axes with the advantage of retaining the cushion in an upright position and secured in the retaining base 2003. In at least one embodiment the cushion is inflatable and has the advantage of being partially filled with weighted filler or ballast material such as sand, fluid or gel to ensure further stability when the cushion is used direction on a floor outside of the retaining base. The cushion 2001 comes in multiple sizes to accommodate different user heights and body types and in at least one embodiment is collapsible and may be filled with air and filler. The retaining base 2003 and sensors 2006 in an interconnected sensor module 2005 stack together and may further stack for instance on a rotating base as in FIG. 1 1008. The modular design and construction of the invention has the advantage that it permits users to exchange components rapidly to suit their desired mode of interaction and body position. The pad sensors 2005 collectively electronically sense pressure and motion to provide input to interactive software when connected by wire or wirelessly to a computing device including a smartphone, tablet, PC, gaming console or other computing devices known to those having skill in the art. The modular design has the added advantage that the integrated sensor module 2006 can be exchanged for different modes of control, feedback, or computer and game console compatibility. A further advantage of modular design is cushions 2001 can be made in multiple sizes to accommodate different user heights and body types and used interchangeably by users.

Referring now to FIG. 3, the construction details of the embodiments shown in FIG. 1 to FIG. 5, the rotating platform previously shown in FIG. 1. 1008 is now shown from above in two component sections, the rotating platform base 3001 and the rotating platform cover 3003 and in profile cutaway 3005. The rotating platform cover 3003 is connected and secured to the base by means of a kingpin at its center 3004. The rotating cover sits upon a rotating base 3001. A cutaway expansion in 3002 shows an expanded view of a ball bearing track 3006 which allows a rotating base cover to rotate about the axis centered with a kingpin 3004. In at least one embodiment a stop mechanism adjusts and limits rotation of the rotating base by means of an adjustable catch. In at least one embodiment the rotating platform utilizes radial ridges 3007 with the advantage of increased rigidity of the rotating platform cover 3003 and rotating platform base 3001. The rotating platform cover utilizes ridges to create an interface with the slots in the retaining base shown in FIG. 2 2003. An electronic circuit board 3008 is mounted to the seat and in at least one embodiment mounted on the rotating platform cover 3003 and interfaces with a wired or wireless interface to interactive sensors FIG. 2 2006 and includes a wire harness, battery, power controller, multi-input processor, positional sensor, magnometer, gyroscope, external power connector and external wired and wireless interface for connection to personal computers, game consoles, mobile devices, handheld gaming devices and other computing devices.

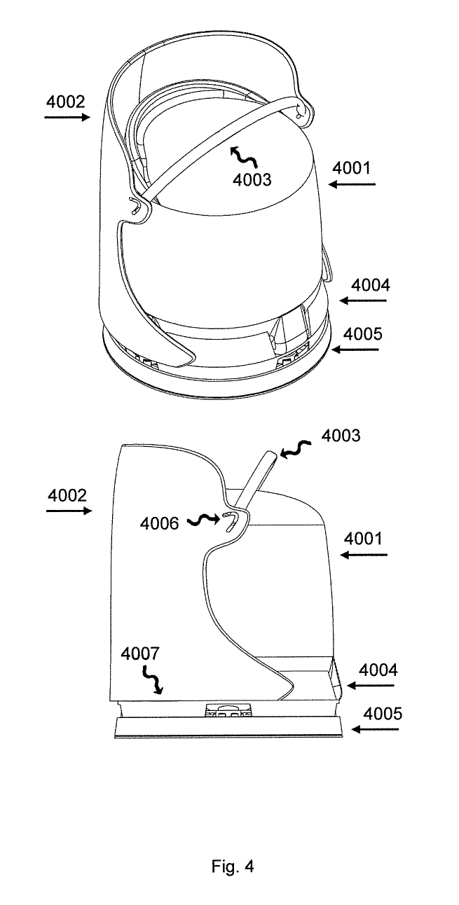

Referring now to FIG. 4, the embodiments in FIG. 1 to FIG. 5, there is shown embodiments of the invention with the addition of a contoured seat back 4002 with the advantage of unobtrusive support for the user's waist and lower back while remaining contoured to avoid cable tangling or interference with foot, leg, and lower body movement. The contoured seat back 4002 rotates with the cushion 4001 and slides on the rotating base 4005 freely along an interface 4007. The back connects as a detachable, or in at least one embodiment integrated, component to the retaining base 4004 and rotating platform cover FIG. 3 3003 with the advantage of allowing the contoured seat back 4002 to rotate with the seat without protrusions or edges that might obstruct movement or catch input device or head mounted display cables. In at least one embodiment the contoured seat back 4002 is modularly connected to the retaining base. The contoured seat back 4002 has the advantage of providing a stable support and friction surface where it makes contact with the cushion 4001 diminishing loose movement of the cushion 4001 improving cushion stability and rigidity. Mounting 4006 for security bracing 4003 attached to the contoured seat back 4002 has the advantage of providing a support point for security bracing 4003 across the lap of the user with little obstruction to leg movement allowing the user to rotate or shift position for interactive control. In one embodiment the security bracing 4003 is a fabric material and in another embodiment the security bracing is a rigid bar that can be held or secured against the waist. The contoured seat back 4002 has the further advantage of providing enough support for the user to remain secure while being contoured to allow legs and hips to work together to provide motion including rotation, movement for interactive control, and balance while immersed with a head mounted display. The contoured seat back 4002 has the additional advantage of integrating multiple functions without obstructing user movement and while promoting user balance through additional lower back and lower body support.

Referring now to FIG. 5, the embodiments shown in FIG. 1 to FIG. 5, there is shown the invention with a user 5001 employing an embodiment of the invention for interactive control while wearing a head mounted display 5002 for interaction with software experiences such as virtual reality, augmented reality, watching interactive video content, design, modeling, 3D computer aided design, or other forms of immersive content interaction. The user 5001 sits on the cushion 5005 with support from the contoured seat back 5003 and in a saddle position with articulated knees 5005 and ankles and feet 5006 with the advantage of a secure and controlled body position while wearing a head mounted display 5002 or utilizing an immersive display. The user 5001 is additionally secured to the invention with a security bracing 5004 with the advantage that if the user were to become unbalanced the security bracing 5004 would provide a physical cue helping the user to rebalance and physical restraint to prevent falling or imbalance.

In further detail, still referring to FIG. 5, the embodiments shown in FIG. 1 to FIG. 5 there is shown the user seated with multiple axes 5007 of movement and motion control. Users may move freely utilizing hands, legs, and head movement through a motion tracking head mounted display 5002 to provide input through one or more motion control devices 5010 while simultaneously providing input by moving in multiple axes 5007 on the present invention detected by interactive sensors 5008 and transmitted to an interactive computing device. Users 5001 may look in one direction providing multiple viewing axes 5011 utilizing a head mounted display 5002 while simultaneously utilizing motion control devices 5010 and simultaneously controlling input along seat multiple seat axes 5012 including yaw, pitch and roll through core body movements of the seat 5009 detected by interactive sensors 5008. In at least one embodiment the direction of the head, arms, and other body parts may also be tracked with motion control devices 5010 not physically connected to the seat and utilizing wired or wireless interfaces and combined electronically with interactive sensors 5008 modularly connected to the seat 5009. The invention has the advantage of allowing the user to utilize short core body movements of the lower body to control motion along multiple axes 5007 moving forward and backward for x axis pitch, left or right for z axis roll, and rotationally for y axis yaw. The invention has the further advantage of detecting and calibrating for weight and sensing up and down user motion through interactive sensors FIG. 1 1006. The invention has the additional advantage of user control of motion input and through small movements while permitting a wide range of gesture based input with hands, rotation, and emulation of walking and movement through core body movements along multiple axes 5007 while having a flexible seating position including a straddle positing conducive to balance control. The invention has another advantage of allowing the user to maintain independent multiple viewing axes 5011 and multiple seat axes 5012 allowing users to provide input to interactive software for viewing direction independent of motion or interactive software function control.

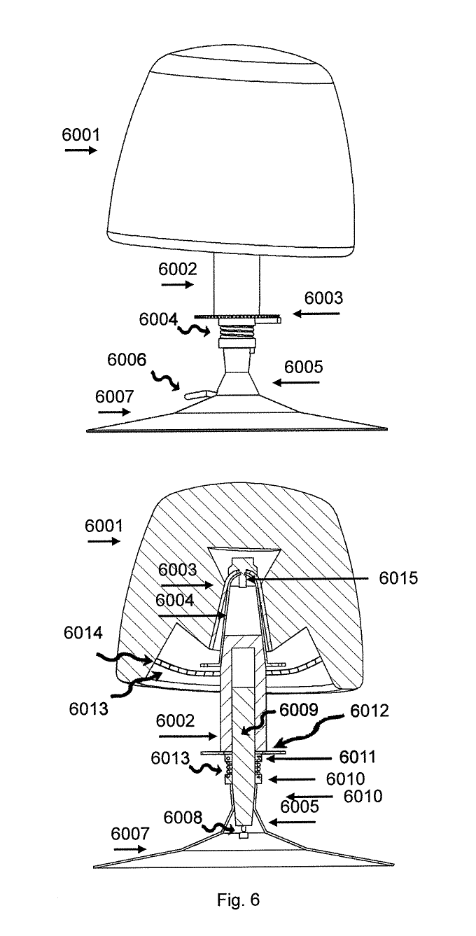

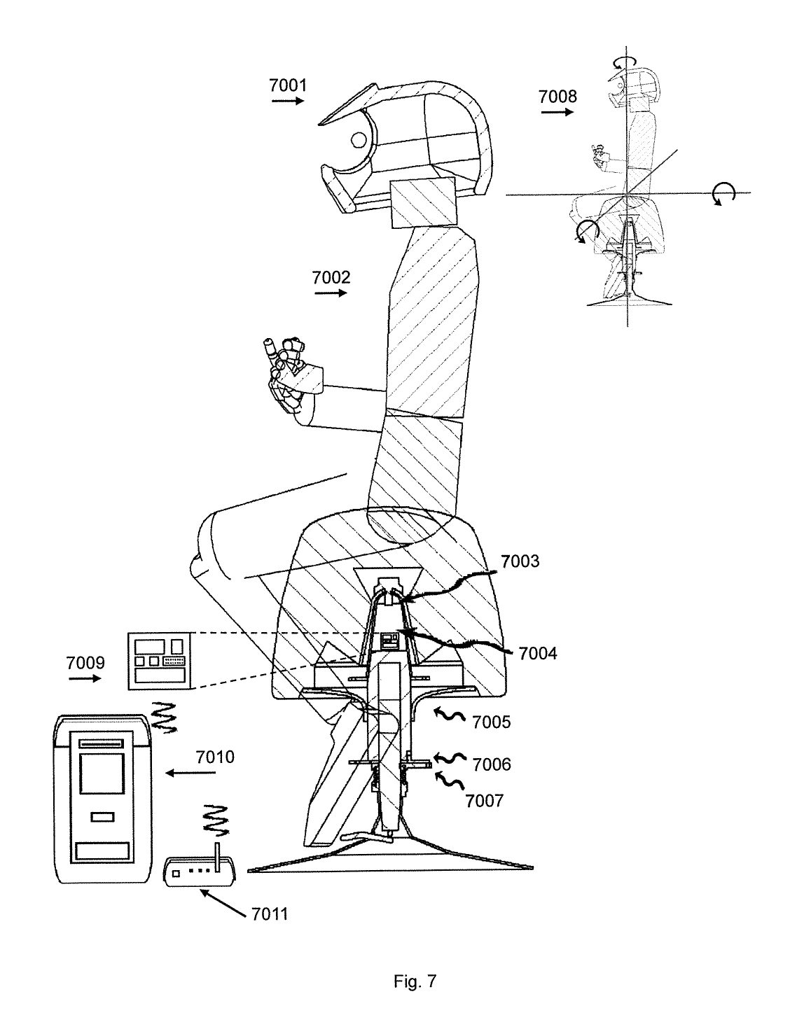

Referring now to FIG. 6, the embodiments shown in FIG. 6 to FIG. 7, there is shown an embodiment of the disclosure with a rotating sensor seat in perspective and in profile. A cushion 6001 is shaped to allow a variety of seating positions including straddle or legs forward with the advantage that a user can freely move between a straddle position for more active motion control and immersion, or moving legs forward for a traditional task-seating legs forward position. The cushion connects to an outer cup 6003 which is coupled to an outer cup 6004 which pivots on an outer cup base providing input to an electronic positional sensor. A shroud 6002 contains a gas cylinder 6009 which is coupled to a spanner spring 6013 compressed between a height adjustment spanner 6011 and a spanner base 6010. A gas cylinder actuator 6008 is controlled by a contoured platform or lever 6006 which is depressed near the base with the advantage of providing hands-free height control. The gas cylinder is coupled to the base at 6005 by pressure fitting securing it to the base assembly 6007. Rotational movement is measured by a rotational sensor reading surface 6012 and an electronic sensor.

In further detail, still referring to FIG. 6 the cushion 6001 extends laterally below the seat sufficient to allow the legs to straddle the cushion. The seat has the advantage of adjustment higher than a traditional task seating seat to allow a free range of motion with the user sitting or sitting with legs extended for more dynamic rotational and pivoting, side to side and front and back movement. The spanner spring 6013 allows positive pressure to be applied allowing the user to maintain contact with the seat while providing motion input through a motion controller or by pivoting and rotating to provide input via the electronic sensors of the invention. The pivoting system of the inner cup 6003 and outer cup 6004 has the advantage of allowing the cushion to pivot with fine precision and user control such that only small movements of the user's lower body are required to tilt the cushion providing motion control input from the electronic tilt sensor.

In additional detail, still referring to FIG. 6, there is shown a centering disc 6014 in the cushion open region 6013 which provides resistance between the cushion 6001 and the shroud 6002 with the advantage of providing a centering force for the cushion 6001 allowing the user to easily return to a centered position. The centering disc 6014 has the further advantage of providing a tactile response and return to neutral position to interactive control provided by the pivoting system of the inner cup 6003 and outer cup 6004 and a positional guide 6015. The centering disc 6014 has the further advantage that it can be offset providing more resistance in one direction more than the other and provide frictional resistance to rotation. In at least one embodiment the centering disc 6014 is composed a polymer as a contiguous piece, segmented, or in additional embodiments composed of a web of woven material with variable degrees of elasticity. In at least one embodiment the centering disk is augmented by a rotating joint that provides adjustable resistance to movement and a natural center point with the advantage that a user can more easily find a forward or home position while rotating in the seat. The centering disk 6014 with multiple material compositions has the advantage of easy tuning to control interfaces integrated in the invention and customization for user preferences and body type. In at least one embodiment the positional guide 6015 is coupled to a positional sensor.

Referring now to FIG. 7, there is shown a side cutaway view of the user 7002 wearing a head mounted display 7001 sitting in a straddle position. The motion of the user 7002 is accomplished through rotation and core movements creating forward and backward and left and right motion creating pivoting motion about a spherical center located below the top of the inner cup and outer cup FIG. 6 6004 and sensed by the sensor unit FIG. 6 6003 with the advantage of small movements providing motion while not upsetting the user's balance and while providing rapid control of interactive movement. The sensitivity of the invention to user 7002 core body movements has the advantage of controlling interactive game movement with realistic response times and without latency for forward and backward walking, sideways walking, virtual object and vehicle control and any additional interactive control where body movement can serve as a control mechanism along multiple axes 7008. Rotational movement is measured by the rotational sensor reading surface 7007 and an electronic sensor 7006. Returning the user 7002 who may be slightly disoriented wearing a head mounted display 7001 to a neutral and upright position for stable control of the motion interface provided by the invention and other input devices is accomplished with the aid of the centering disk 7005 which has the advantage of returning the user with minimal effort to a neutral position and guided motion along multiple axes 7008. An electronic circuit board 7009 is mounted to, and shown within the inner cup 7004 with the advantage of creating wired or wireless interfaces between seat sensors and a computer 7009, mobile device, handheld gaming device or other computing device. In some embodiments the electronic circuit board 7009 transmits signals using wife and TCP/IP enabling an internet connection to a wired or wireless access point 7011 with the advantage of enabling motion output from the seat to be transmitted over the internet to local or remote computers and interactive computer software. In some embodiments, motion control devices and head mounted displays may be routed through the seat to the electronic circuit board through data connections such as USB and video connections such as HDMI and relayed to local or remote computers and interactive computer software with the advantage of utilizing the interface in the chair as a hub for motion control devices and head mounted displays.

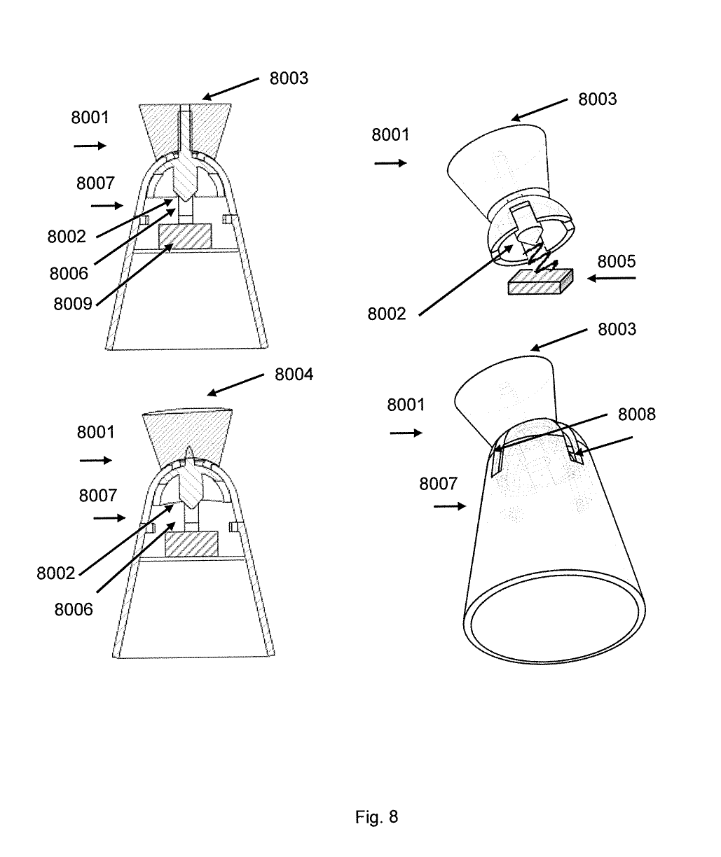

Referring now to FIG. 8, there is shown a side cutaway view and a perspective view of an embodiment of the disclosure where motion is translated from a cushion FIG. 6 6001 to pivoting cap 8003 connected to a positional guide 8002 with the advantage of allowing movement between neutral or level position 8003 and a deflected or pivoted position 8004. In at least one embodiment the pivoting cap 8003 is coupled to an outer cup FIG. 6 6003 to constrain movement of the cushion FIG. 6 6001 about the inner cup 8007. The pivoting cap 8001 is connected by a center pin and rotates according to guides 8008 of the inner cup 8007 to provide guided movement on multiple axes detected through the movement of the positional guide 8002. In at least one embodiment the positional guide 8002 is coupled to a wired or wireless joystick or positional input device. In at least one embodiment the positional guide 8002 contains a wired or wireless joystick or positional input device. In at least one embodiment the positional guide connects to a joint which prevents rotational movement of the cushion FIG. 6 6001 relative to the rotational sensor FIG. 7 7006 such that seat rotation can be measured by the rotational sensor without multiple points of rotation. In at least one embodiment the inner cup 8007 has grooves 8008 guiding the pivoting cap 8001 with the advantage of secure but constrained translation of user FIG. 7 7002 motion to mechanical articulation of a positional guide 8002 whose movement can be detected. In one embodiment movement of the positional guide 8002 is detected by magnetic, optical or electrical effect by a wireless positional sensor 8005. In at least one embodiment the positional guide 8002 is coupled to an electrical mechanical positional sensor 8003 by a mechanical sensor couple 8006. A mechanical sensor couple has the advantage of allowing free movement of the positional guide 8002 while remaining connected to the electrical mechanical sensor 8009 similar to the control of a finger on a joystick, where finger joints allow a finger to freely guide movement of a mechanical stem of a joystick while remaining in contact. In at least one embodiment the electrical mechanical sensor 8009 or wireless sensor 8005 are operatively coupled to an electronic circuit board FIG. 7 7009 with the advantage of providing motion input to a computing device. The electronic connection may be wired or wireless and include power and data connections.

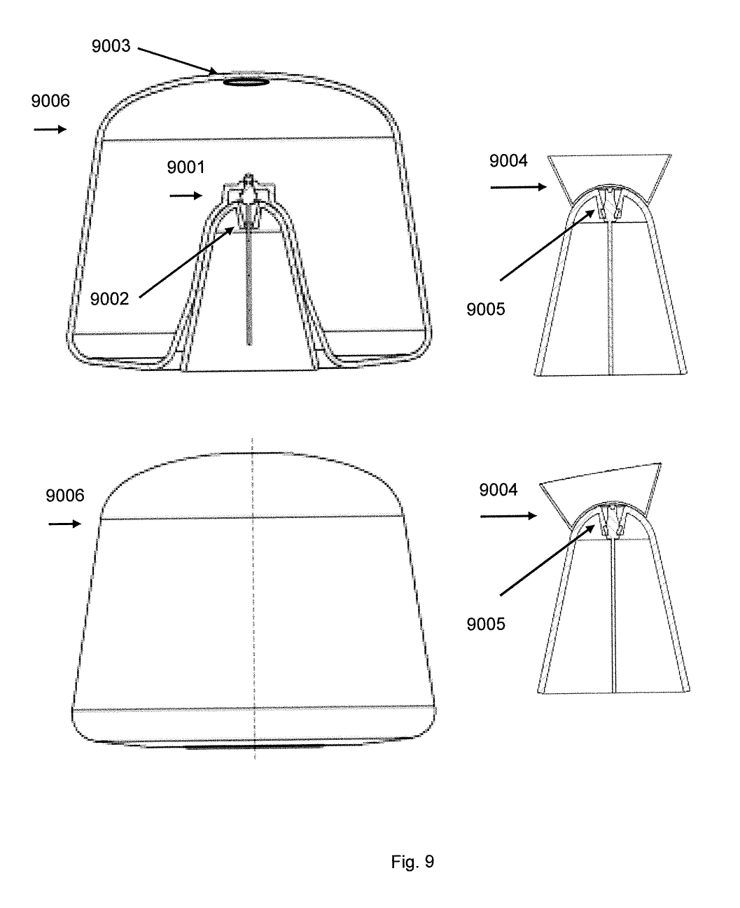

Referring now to FIG. 9, there is shown a side view and side cutaway detail views where motion translates to movement of a cushion 9006 by means of optical sensing. In at least one embodiment an optical far sensor 9002 which tracks movement of an optical marker 9003 positioned on the inside of the seat cushion 9006. The optical far sensor 9002 reading the optical marker positioned on the underside of the seat 9003 has the advantage of measuring body movement just underneath the seated user FIG. 7 7002 for detection of fine movements on multiple axes including up and down and left and right movement. In at least one embodiment the optical far sensor 9002 is reaches inside the cushion forming a cushion sensor couple 9001 which allows it to remain prone while the cushion moves. In at least one embodiment the optical far sensor 9002 is integrated as a plug for an inflatable cushion. In at least one embodiment an optical near sensor 9005 reads movement of an articulating pivoting cap 9004. The optical near sensor 9002 reading the movement of an articulating cupped surface 9004 has the advantage of providing input similar to a track ball being able to translate motion of the full cushion 9006 from the user FIG. 7 7002 with precise sensor measurement and tight mechanical interface. The optical far sensor 9002 or optical near sensor 9005 is electronically connected to an electronic circuit board FIG. 7 7009 via a wired or wireless interface with the advantage of providing motion input to an interactive computing device.

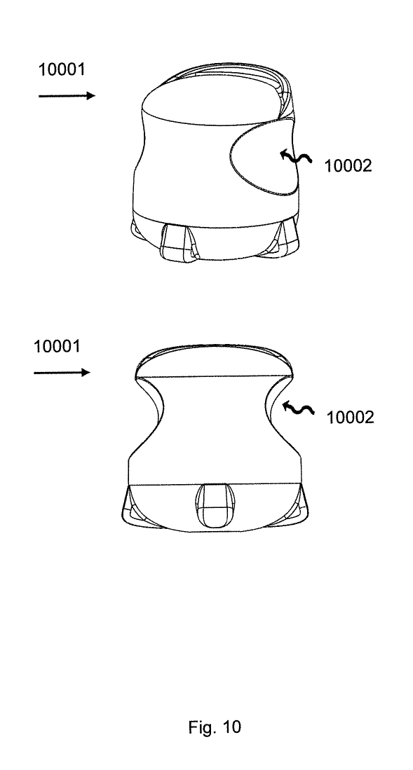

Referring now to FIG. 10 there is shown a perspective view and a side view where the cushion 10001 includes contoured surfaces 10002 with the advantage of providing additional support for the legs of a seated user enabling a straddle position and more precise control of lower body, leg and foot movement. In at least one embodiment the contoured surfaces are indentations on a seat cushion. In at least one embodiment the contoured surfaces involve an adjustable surface.

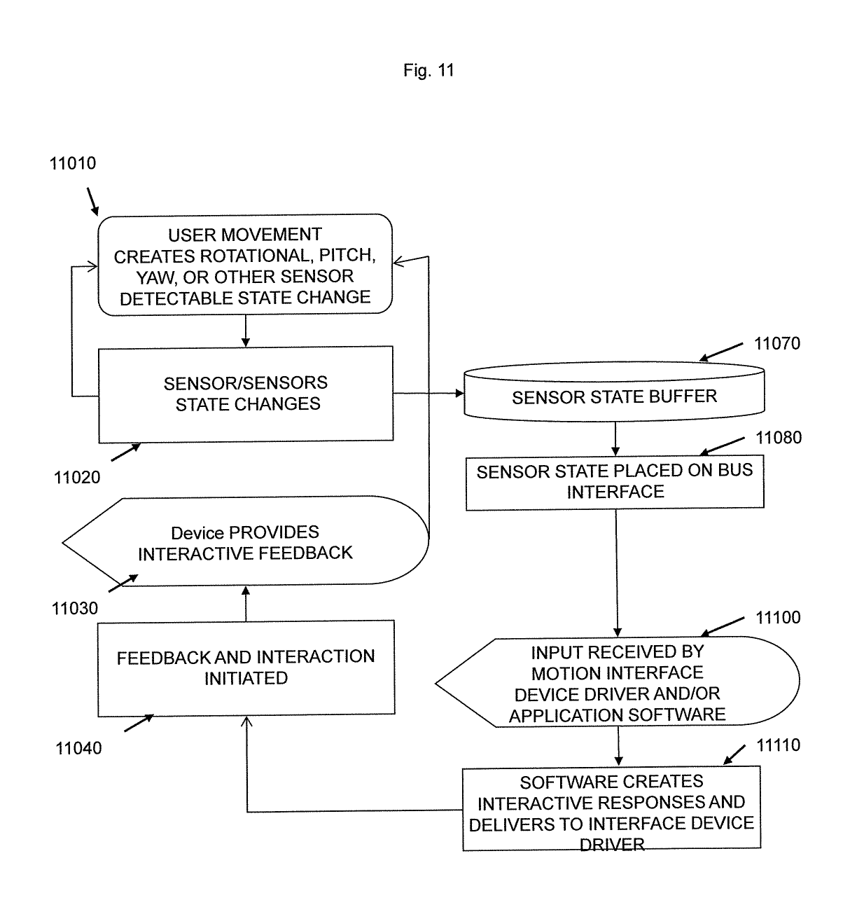

Referring now to FIG. 11 there is shown a flow chart of the translation of movement from the input device into electronic signals and instructions for computing devices. The translation of movement is accomplished by electronic polling of sensors for state and changes and relaying these signals via an electronic interface including the embodiment of the electronic circuit board FIG. 7 7009 and FIG. 3 3008 to computers, mobile devices such as smartphones and tablets, handheld gaming devices, head mounted computing devices, head mounted computing devices with head mounted displays, and other computing devices. Feedback and interaction may also be provided by software input from these devices to interactive sensors such as those in FIG. 2 2006 for feedback including but not limited to sound, vibration, light, light effects, steam or smoke, and other interactive effects. In some embodiments lighting of the cushion may indicate desired states of the user such as red for do-not-disturb or green for available.

User movement on the input device creates rotational, pitch, yaw or other sensor detectable state change 11010. Sensors of the input device undergo state change(s) 11020 as a result of user movement on the input device. The state change(s) are communicated to a sensor state buffer 11070. The sensor state is placed on a Bus interface 11080. The result is an input signal received by a motion interface device driver and/ or application software 11100. As a result of the input signal the software creates interactive response(s) and delivers it to an interface device driver 11110. As a result feedback and interaction elements may be initiated 11040 causing the device to provide interactive feedback, such as haptic feedback, or other user feedback known to those having skill in the art. Following the provision of interactive feedback, and contemporaneous to the provision of interactive feedback, the device continues to detect user movement and convert that movement into detectable state changes in the device's sensors.

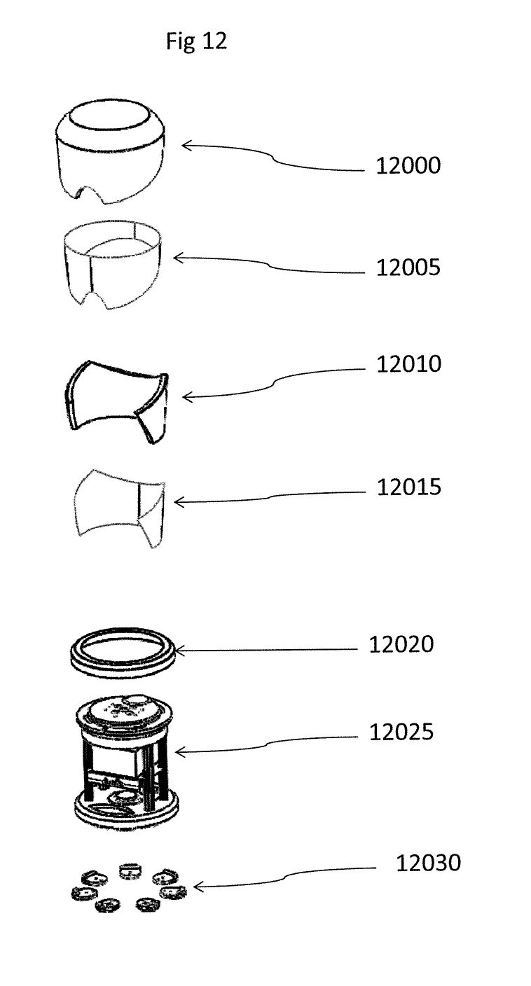

Turning now to FIG. 12 in which an exploded view of an embodiment of the input device is shown. The input device in this embodiment comprises an ergonomic seating surface 12000 which couples to an endo/exoskeletal seating 12005. A shroud surface 12010 and endo/exoskeletal shroud 12015 surrounds the endo/exoskeletal seating 12005. A system chassis 12025 serves as a central support structure to which the other components are attached. The system chassis sits on a plurality of feet 12030. The feet serve aesthetic functions as well as serving to adjust the height of the device. The feet may further comprise casters for rotation/translation. The feet may further comprise fixed tangential wheels for axial rotation. A foot ring/trim bezel/kick plate 12020 fits over the base of the system chassis.

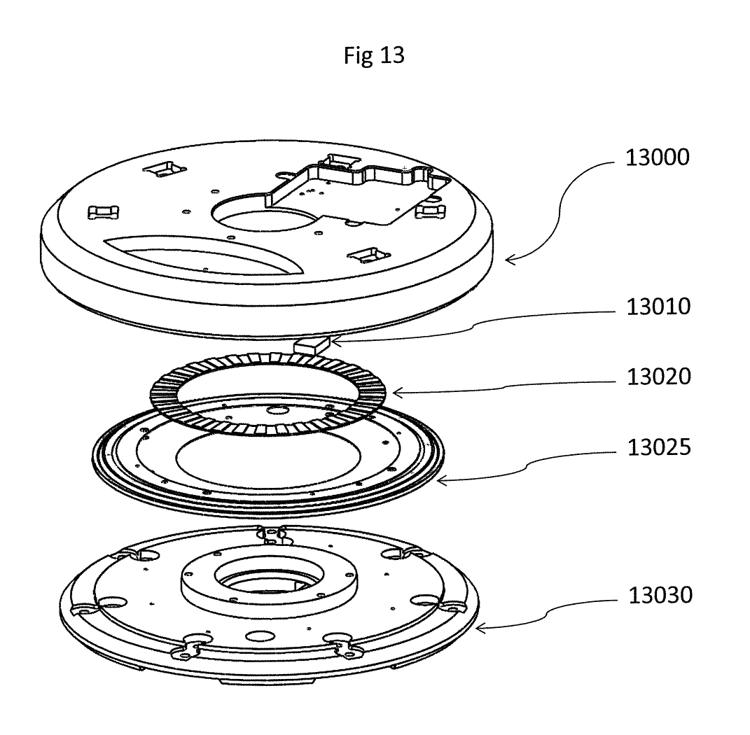

FIG. 13 shows an embodiment of a rotation assembly of an embodiment of the device and comprises a rotating portion 13000 which in this embodiment holds the sensor and seating surface structure, a rotation sensor pickup 13010, a rotation indicator 13020, a turntable 13025 and a stationary base portion 13030.

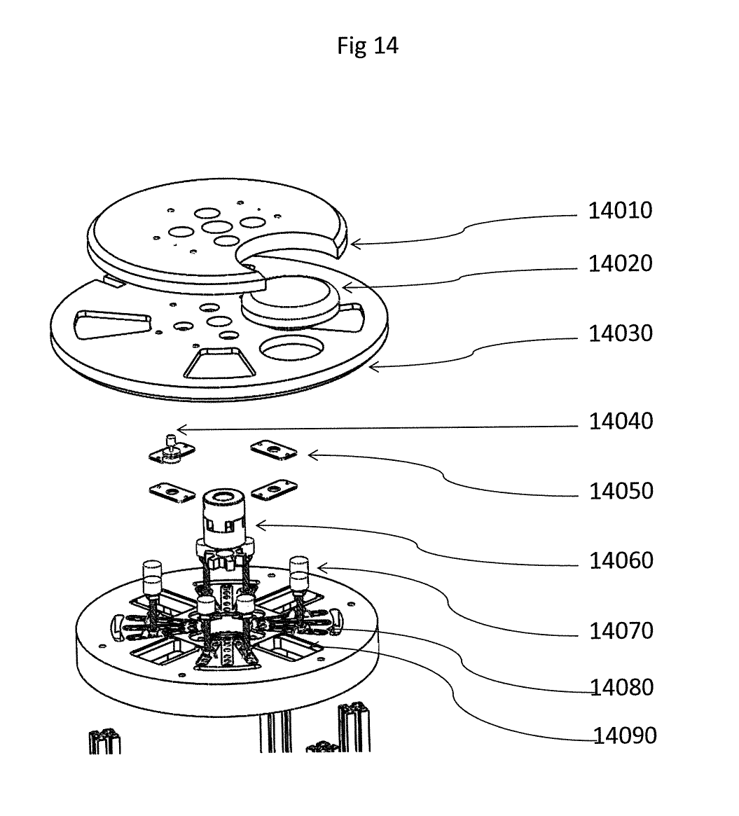

FIG. 14 shows an exploded view of a directional seat portion of an embodiment of the input device. The seat portion further comprises a lower seat support 14030 onto which is mounted an upper seat shape cutout 14010, which provides space for the inclusion of a haptic feedback device 14020. A seat switch assembly 14040 which in this embodiment comprises 4 switches that are mapped to the “W”, “A”, “S”, “D” keys of a keyboard is included. A joint 14060 sits between the chassis and the directional seat portion. Shafts 14070 are adjustable for elevation and location and serve as fulcrums for seat pivoting. Shaft holes 14080 for adjustable fulcrums position points for seat pivot and a switch carrier 14090 for adjustment range mounting surfaces are also provided.

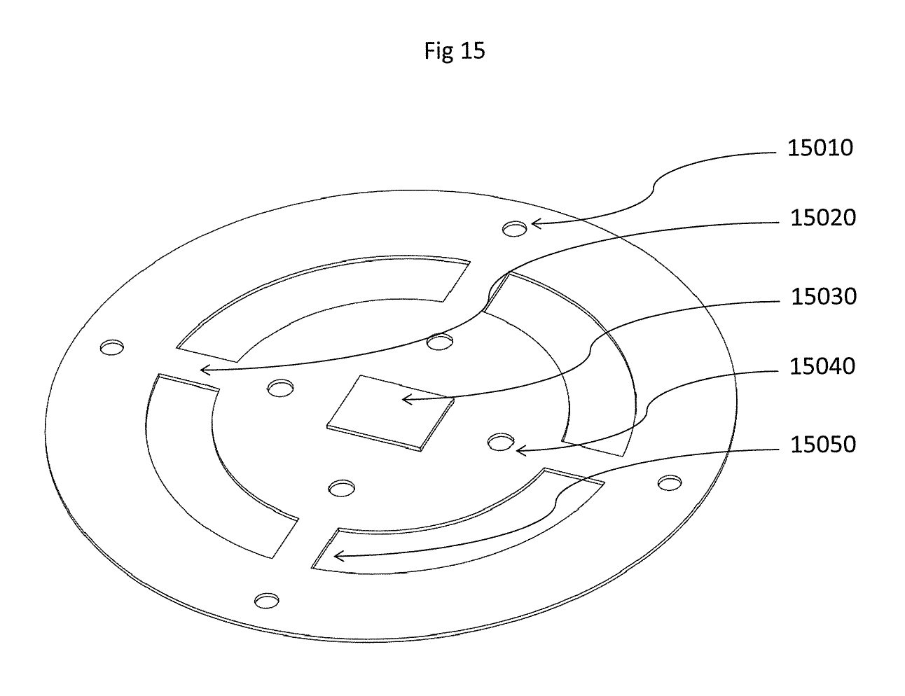

FIG. 15 shows a gimbal that reduces a digital on/off switch scenario to a simple one board solution. The gimbal comprises outer mounts 15010, in this case, seat mounts, a gimbal X-axis spanner 15020, a gyro/accelerometer/anglo meter sensor 15030, inner mounts 15040, in this case chassis, and a gimbal Y- axis spanner 15020.

The present invention is not to be limited in scope by the specific embodiments described herein. Indeed, various modifications of the invention in addition to those described herein will become apparent to those skilled in the art from the foregoing description. Such modifications are intended to fall within the scope of the appended claims.

All references cited herein, including all patents, published patent applications, and published scientific articles, are incorporated by reference in their entireties for all purposes.

1. (canceled)

2. An input device comprising:
a floor engaging member having a floor engaging surface and a longitudinal axis generally perpendicular to the floor engaging surface;
a skeleton support structure having a seat support surface generally parallel to the floor engaging surface;
a bearing disposed between the skeleton support structure configured to allow relative rotation of the skeleton support structure about the longitudinal axis with respect to the floor;
a seat support;
a coupling member disposed between the seat support and the seat support surface the coupling member pivotably coupling the seat support surface to the seat support member in a manner which restricts the rotation of seat support with respect to the support skeleton about the longitudinal axis and allows for the rotation of the seat support member in a plurality of directions perpendicular to the longitudinal direction; and
a plurality of sensors configured to detect the movement of the seat support with respect the seat support surface and provide a signal thereof.

3. The input device according to claim 2, further comprising a first, a second and third bumpers each radially disposed about the longitudinal axis.

4. The input device according to claim 2, wherein the plurality of sensors configured to detect the movement of the seat support are radially disposed about the longitudinal axis at a first radial distance from the longitudinal axis.

5. The input device according to claim 3, wherein the first and second bumpers are disposed at a second radial distance from the longitudinal axis, the second radial distance being less than the first radial distance.

6. The input device according to claim 5, wherein the third bumper is disposed at a third radial distance from the longitudinal axis, the third radial distance being less than the first radial distance and different than the first radial distance.

7. The input device according to claim 3, further comprising a plurality of holes configured to allow the selective placement of the first and second bumpers.

8. The input device according to claim 3, wherein the first and second bumpers comprise vertical adjustment.

9. The input device according to claim 2 wherein the input device comprises at least one binary on/off switch which provides a digital output signal.

10. The input device according to claim 2 wherein the input device comprises at least one analog sensor which provides an analog output signal.

11. The input device according to claim 8 wherein the analog sensor detects one of the change in resistance and a change in capacitance.

12. A virtual reality system comprising:
a floor engaging member having a floor engaging surface and a longitudinal axis generally perpendicular to the floor engaging surface;
a skeleton support structure having a seat support surface generally parallel to the floor engaging surface;
a bearing disposed between the skeleton support structure configured to allow relative rotation of the skeleton support structure about the longitudinal axis with respect to the floor;
a seat support;
a coupling member disposed between the seat support and the seat support surface the coupling member pivotably coupling the seat support surface to the seat support member in a manner which restricts the rotation of seat support with respect to the support skeleton about the longitudinal axis and allows for the rotation of the seat support member in a plurality of directions perpendicular to the longitudinal direction; and
a first plurality of sensors configured to detect the rotational movement of the skeleton support structure with respect the floor engaging surface and provide a first signal thereof, and a second plurality of sensors configured to detect the rotational movement of the seat support with respect the seat support surface and provide a second signal thereof.

13. The virtual reality system according to claim 12, further comprising a first, and a second pairs of bumpers each radially disposed about the longitudinal axis.

14. The virtual reality system according to claim 12, wherein the second plurality of sensors are configured to detect the movement of the seat support are radially disposed about the longitudinal axis at a first radial distance from the longitudinal axis.

15. The virtual reality system according to claim 14, wherein the first pair of bumpers are disposed at a second radial distance from the longitudinal axis, the second radial distance being less than the first radial distance.

16. The virtual reality system according to claim 15, further comprising a head mounted display, the head mounted display having a third plurality of sensors configured to measurement the relative movement of the display and producing a third signal indicative of rotation of the head mounted display.

17. The virtual reality system according to claim 16, wherein the display is configured to produce a series of pictures in response to changes in signals produced by the first, the second, and third signals.

18. The virtual reality system according to claim 12, wherein the first and second pairs of bumpers comprise vertical adjustment.

19. The virtual reality system according to claim 12 wherein the input device comprises at least one binary on/off switch which provides a digital output signal.
